(19) United States
(12) Patent Application Publication
(10) Pub. No.: US 2021/0176934 A1
(43) Pub. Date: Jun. 17, 2021

(54) INTEGRATED HYDROPONIC PLANT CULTIVATION SYSTEMS AND METHODS

(71) Applicant: Foshan GrowSpec Eco-Agriculture Technology Co. Ltd, Foshan (CN)

(72) Inventors: Jian Su, Foshan (CN); Wei Feng, Beijing (CN); Rongju Lao, Foshan (CN); Hao Sun, Foshan (CN)

(21) Appl. No.: 17/119,736

(22) Filed: Dec. 11, 2020

Related U.S. Application Data
(60) Provisional application No. 62/946,439, filed on Dec. 11, 2019.

(51) Int. Cl. A01G 31/02; A01G 7/04

(52) U.S. Cl. CPC A01G 31/02; A01G 7/045

(57) ABSTRACT

The present application is directed to a hybrid hydroponic and aeroponic plant cultivation system comprising a main reservoir supplying a nutrient solution to a root mass contained within an interior cavity of a cultivation chamber having a lateral sidewall and a chamber outlet, the lateral sidewall having a top edge and a bottom edge, wherein the chamber outlet is configured to allow drainage of the nutrient solution from the interior cavity of the cultivation chamber. Attached to the chamber outlet is a nutrient solution retention system comprising a drainage conduit, a bypass conduit, and a liquid level switch operatively coupled to the drainage conduit, wherein the liquid level switch is configured to restrict the flow of nutrient solution through the drainage conduit causing the root mass to be submerged in a volume of nutrient solution retained in the cultivation chamber.

### CROSS-REFERENCE TO RELATED APPLICATION

The present application claims the benefit of priority to U.S. Provisional Application No. 62/946,439, filed Dec. 11, 2019, the contents of which are herein incorporated by reference.

### FIELD OF THE INVENTION

The present invention relates generally to the fields of hydroponics and aeroponics, and more particularly to a plant cultivation system adapted to provide uniform lighting distribution and maintain a desirable microenvironment throughout all growth stages of a plant as controlled by a centralized system controller.

### BACKGROUND OF THE INVENTION

As the global population grows and arable land becomes increasingly scarce, new methods for cultivating plants and crops are necessary. To meet this demand, cultivating crops indoors has become a popular alternative. One promising alternative is in the areas of hydroponics and aeroponics, a subset of hydroponics. Compared to traditional outdoor soil grown plant cultivation, hydroponics and aeroponics use water more efficiently, increase crop production, decrease the time between harvests, allow farming in a controlled environment away from natural hazards, and reduce the need for chemical, weed, or pest control products.

While the past few years of research and development have yielded significant advancements in our ability to control temperature and humidity in hydroponic grow environments, continued inefficiencies in lighting and irrigation have prevented hydroponic plant cultivation from achieving its full potential. As the commercialization of hydroponic plant cultivation becomes apparent, a different approach to innovation is required. Embracing industrial solutions in view of traditional agricultural solutions can produce healthier crops and higher yields.

Operating an indoor cultivation environment presents unique challenges. One of the challenges facing hydroponics and other indoor cultivation techniques is uneven light distribution produced by artificial lighting. Unlike traditional outdoor cultivation that benefit from natural sunlight, indoor cultivation techniques use artificial lighting to maximize efficiencies and produce year-round growth cycles. However, current solutions to artificial lighting produces uneven light distributions within the grow area. When light hits a plane, the center of the area illuminated by the light has a higher intensity of light while the emission intensity along the edges is weaker. Receiving too much or too little light will produce poor plant growth.

In addition to producing even horizontal light distribution, it is also important for growers to achieve even vertical light distribution. Current lighting solutions utilize lamps at fixed points that cannot be automatically adjusted based on the height of the plant. As measured by photosynthetically active radiation (PAR) within a defined space, commonly referred to as photosynthetic photon flux density (PPFD), the PPFD is inversely proportional to the distance between the light source and the plant canopy. Thus, during the early stages of plant growth, the young plants tend to receive insufficient light radiation.

Growers also need to closely monitor their use of water and nutrient solution to avoid excess and waste. Current methods of irrigation fail to efficiently utilize water and nutrient solution. For example, drip irrigation is a commonly used method of irrigation where the water and nutrient solution is allowed to drip slowly directly onto the plant. However, the water and nutrient solution used in drip irrigation is expensive and unused nutrients cannot be recovered. Instead, nutrient solution not absorbed by the plant roots is either lost or evaporated into the air. Furthermore, in traditional hydroponics where the roots of the plant are submerged in a water and nutrient solution, the amount of solution required is more than five times greater than that used in substrate based drip irrigation.

For the cultivation of healthy plants, growers further need to manage and reduce root rot, mold, and insect infestation. The presence of root rot, mold or insect infestation can cause harm to the plant and reduce plant vigor. At present, these issues are commonly found in substrate cultivation as well as hydroponic cultivation. The cause of these issues can be attributable to the inability of the roots to breathe or by bacteria growth as a result of excess nutrient solution in the area of surrounding the roots of a plant, otherwise known as the root zone.

There remains a need for a plant cultivation apparatus and solution that allows growers to standardize the equipment and processes in a controlled environment away from natural hazards to reduce nutrient waste, increase crop production, and regulate the environmental factors needed to produce healthy plants. It would be beneficial if such a system could automatically adjust the distance between the grow lights and the plant canopy based on the height and growth stage of the plant. It would further be beneficial if such a system could have an integrated control unit for regulating and maintaining irrigation of the plants.

### SUMMARY OF THE INVENTION

In accordance with the foregoing objectives and others, methods, systems, and apparatuses, including computer programs encoded on computer storage media, are provided for managing and monitoring the cultivation of plants. The described embodiments provide for a fully integrated hybrid hydroponic and aeroponic indoor plant cultivation system to facilitate and promote the efficient use of resource while maximizing plant harvests. The present invention provides a hydroponic growing apparatus which can be effectively utilized in both commercial and industrial applications.

In the described embodiments, a water and nutrient solution is circulated through a hydroponic plant cultivation system by an outlet pump through a UV lamp and filter module before injection into a plurality of planting buckets through nozzles directed at the roots of a plant situated in the planting bucket. Nutrient solution not absorbed by the plant's roots descend into the base of the planting bucket where excess nutrient solution is drained from the planting bucket through a base aperture at the base of the planting bucket. In preferred embodiments, a liquid level switch may be utilized to allow nutrient solution to pool at the base of the bucket submerging the roots of a plant in a planting bucket. As result, based on position of the liquid level switch, the roots of the plant can either receive nutrient solution solely through a nutrient solution mist produced by nozzles or through a combination of a nutrient solution mist and submergence in a pool of nutrient solution. In some embodiments, the amount of nutrient solution retained in the planting bucket can be adjusted by the user and is based on the height of a bypass channel contained in the liquid level switch.

The plant cultivation system may be controlled by a central system controller which houses all the components needed to provide and control nutrient solution distribution to a plurality of planting buckets. The system controller may comprise software and hardware components as well as operational components for plant irrigation including, but not limited to, a power source, an interface display, a liquid pressure gauge, a filter module, a UV lamp, a main reservoir and a main outlet pump. In other embodiments, the system controller may also include a secondary reservoir and a secondary pump.

### BRIEF DESCRIPTION OF THE DRAWINGS

FIG. 1 is a perspective view of an indoor plant cultivation system in accordance with one embodiment of the invention.

FIG. 2 is a diagram of the nutrient circulation pathway in accordance with one embodiment of the invention.

FIG. 3 is an enlarged view of the lighting assembly illustrating the height adjustable assembly in accordance with one embodiment of the invention.

FIG. 4 is a perspective view and component level view of a planting bucket in accordance with one embodiment of the invention.

FIG. 5a is a side-view and enlarged perspective view of the liquid level switch in the normal (open) position allowing nutrient solution to flow through the drainage conduit in accordance with one embodiment of the invention.

FIG. 5b is a side-view and enlarged perspective view of the liquid level switch in the bypass (closed) position allowing nutrient solution to flow through a bypass channel in accordance with one embodiment of the invention.

FIG. 6 is side-view of a series of planting buckets sharing a common drainage conduit leading to a liquid level switch in accordance with one embodiment of the invention.

### DETAILED DESCRIPTION

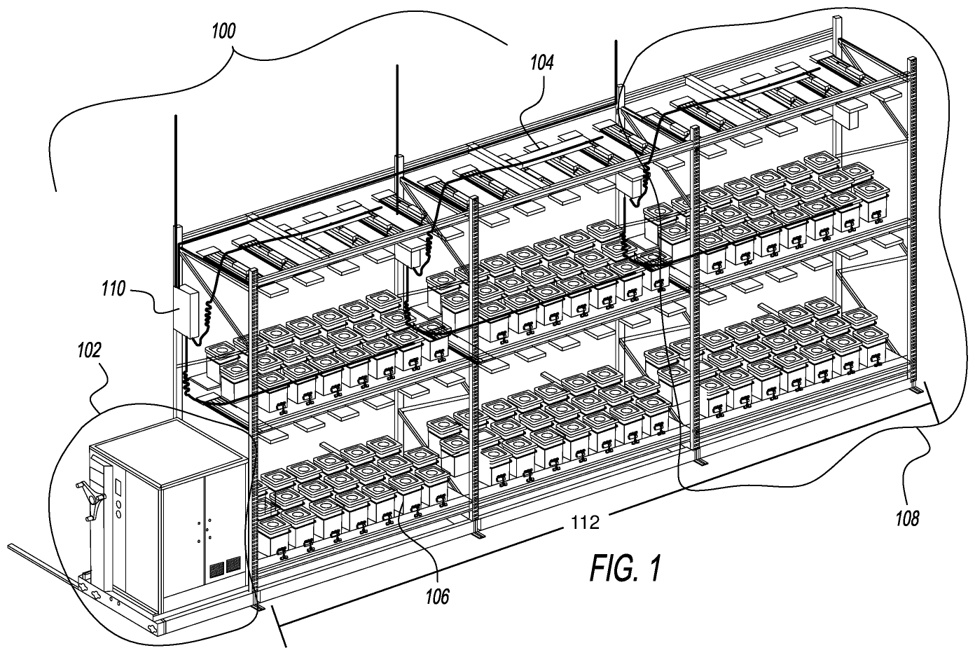

Various methods, systems and apparatuses are discussed herein that describe a fully integrated hybrid hydroponic and aeroponic indoor plant cultivation system 100, as seen in FIG. 1, to facilitate and promote the efficient use of resource while maximizing plant harvests.

### Central System Controller

The system controller 102 illustrated in FIG. 1 houses all the components needed to provide and control nutrient solution 201 distribution to a plurality of planting buckets. The system controller 102 may comprise software and hardware components as well as operational components for plant irrigation including, but not limited to, a power source, an interface display, a liquid pressure gauge 211, a filter module 209, a UV lamp 207, a main reservoir 203 and a main outlet pump 205. In other embodiments, the system controller 102 may also include a secondary reservoir and a secondary pump 215.

The system controller 102 may include a power source utilized to power the electrical components. In certain embodiments, a system controller 102 may comprise a removable power source that attaches to the controller and an auxiliary power source 110 contained within the device. In other embodiments, an auxiliary power source 110 is used to provide power for the electrical components in a grow tower 108. Multiple auxiliary power sources 110 may be utilized for multiple grow towers 108 where each auxiliary power source 110 is used to power one or multiple grow towers 108.

In exemplary embodiments, an interface display may be provided to control the timing and/or scheme for the lighting schedule. The interface display may also provide control for the irrigation schedule. To provide for interaction with a user, the interface display may be any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). In some embodiments, the interface display may be a touch screen allowing a user to input information using directly from the interface display without an additional input device. Input from the user can be received in any form, including acoustic, speech, or tactile input. Moreover, feedback may be provided to the user via any form of sensory feedback such as visual feedback, auditory feedback, or tactile feedback.

In preferred embodiments, the irrigation schedule may be determined by user input. In this manner, irrigation occurs according to a predetermined or default schedule, but the default schedule may be preempted by other conditions such as current soil moisture. A user may also designate different schedules for each stage of a plant's growth cycle. Further, each component of the system controller, such as the lights, fans, or pumps, may be turned on or off individually. In similar fashion, the lighting schedule may also be controlled by the interface display. Users may use the interface display to turn on and off the grow lights individually or collectively. The interface display may also allow a user to set a schedule based on time of day, seasons, grow cycle, stages of plant growth and characteristics of the plant, such as height and canopy density. Furthermore, the interface display may also allow a user to control the height of the lighting assembly 140 based on the same factors.

Two liquid pressure gauges 211 may be utilized to take pressure readings of the nutrient solution 201 immediately before the solution enters the filter module 209 and immediately after the nutrient solution 201 exits the filter module 209. The difference between the pressure readings of the two liquid pressure gauges 211 may be used to determine whether to change the filter module 209 based on user observation or through a combination of software and hardware operations. A UV lamp 207 may be employed to provide disinfection or sterilization of the nutrient solution 201.

In certain embodiments, a secondary pump 215 is provided to supply a water and nutrient solution 201 from a temporary reservoir to the main reservoir 203. The secondary pump 215 may be a centrifugal pump. The temporary reservoir may also be adapted with a plurality of float switches to monitor the level of the nutrient solution 201 in the temporary reservoir. For example, a first float switch may be adapted to stop the secondary pump 215 from operating if the water level is lower than the level designated by the first float switch. A second float switch may be adapted to actuate the secondary pump 215 when the water level rises above a second designated level. A third float switch may be adapted to trigger an audio and/or visual alarm if the water level rises above a third designated level. The float switches may be activated by a liquid level switch 213 when the bypass channel 406 is in use.

In various embodiments, the system controller 102 may be hardware, firmware, and/or software based. The system controller 102 may be a part of one or more applications of a computing device. The system controller 102 may also be a standalone hardware device that communicates with a software application using built in firmware. The system controller 102 may receive data through physical connections with a microcontroller, or alternatively through a network interface that is connected to a microcontroller through Ethernet controllers.

The system controller 102 may receive commands from a programmed application or user inputted commands. The commands may be provided all at one time, incrementally, or updated at intervals. The system controller 102 may output data electronically or mechanically and may be received by the lighting assembly 140 through a network interface or direct connection. Electronic and mechanical outputs may include signals that control the lighting assembly 140 to regulate light intensity or the height of the lighting assembly 140. Electronic and mechanical outputs also may regulate watering intervals, volumes, and durations. In some embodiments, the height of the lighting assembly 140 may be adjusted higher or lower through a motorized cable or pulley system 206 that lifts or lowers the lighting assembly 140 relative to the plants.

In various embodiments, a system controller 102 may be hardware, firmware, and/or software based. The system controller 102 may be a part of one or more applications of a computing device. The system controller 102 may also be a standalone hardware device that communicates with a software application using built in firmware.

The system controller 102 may receive data through physical connections with a microcontroller, or alternatively through a network interface that is connected to a microcontroller through Ethernet controllers. Sensors that may be utilized are not limited in any manner, thus allowing any data relevant to an optimized horticultural application to be interpreted and utilized by the tandem operation of the system controller 102 and lighting assembly 140. In some embodiments, multiple sites may be employed to house multiple grow facilities. Each grow facility can be adapted to include multiple system controllers, grow towers, and storage racks 106. The system controllers in each of the grow facilities may be controlled using the internet, WiFi, local area network or another wireless communication scheme via a mobile or desktop device.

The system controller 102 may receive commands from a programmed application or user inputted commands. The commands may be provided all at one time, incrementally, or updated at intervals. The system controller 102 may output data electronically or mechanically and may be received by the lighting assembly 140 through a network interface or direct connection. Electronic and mechanical outputs may include signals that control the lighting assembly 140 to regulate light intensity or the height of the lighting assembly 140. Electronic and mechanical outputs also may regulate watering intervals, volumes, and durations. The outputs of the system controller 102 may also regulate the supply of nutrient solution 201 and photoperiod management, sterilization and disinfection, and nutrient solution 201 refrigeration. In some embodiments, the height of the lighting assembly 140 may be adjusted higher or lower through a motorized cable or pulley system that lifts or lowers the lighting assembly 140 relative to the plants.

The disclosed system may be modular and scalable in nature. As discussed below, the grow towers, storage racks 106, and the planting buckets 300 may provide for a multi-container grow environment in which a plurality of storage racks 106 may be placed adjacently, stacked or otherwise arranged to establish a large quantity of growing plants in an efficient and cost-effective manner.

It will be apparent to one of ordinary skill in the art that, in certain embodiments, any of the functionality of the system controller 102 may incorporated into a network connected device.

### Circulation of Water and Nutrient Solution

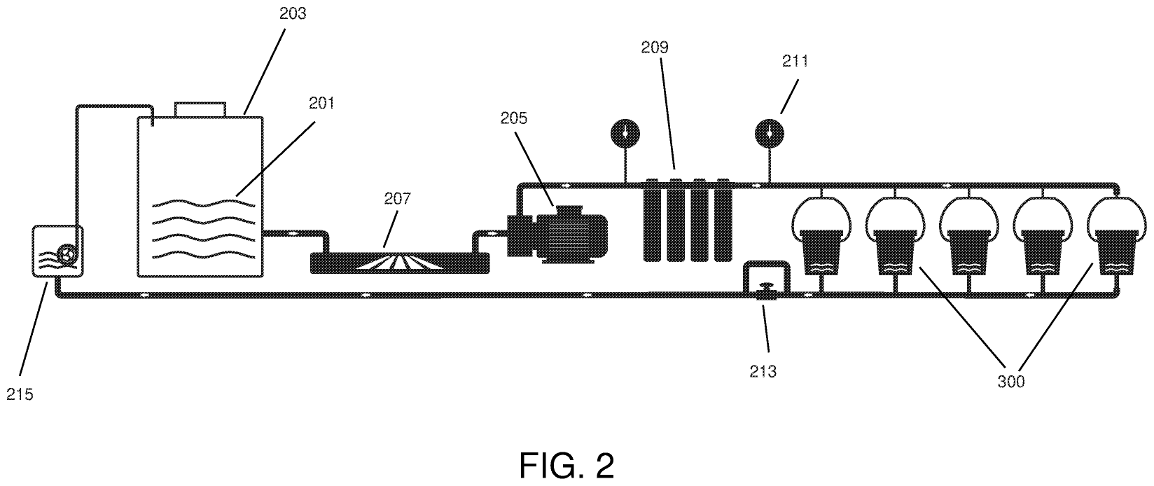

FIG. 2 illustrates the circulation pathway of the water and nutrient solution 201 in a preferred embodiment of the plant cultivation system. Desired nutrient solution 201 may be placed in a main reservoir 203. Nutrient solution 201 may be circulated through the system through a fluid deliver channel via an outlet pump 205. In some embodiments, the nutrient solution 201 flows through a UV lamp 207 and filter module 209 before injection into a plurality of planting buckets 300 through nozzles directed at the roots of a plant situated in the planting bucket. Nutrient solution 201 not absorbed by the plant's roots descend into the base of the planting bucket 300 where the excess nutrient solution 201 is drained from the planting bucket 300 through a base aperture 307 at the base of the planting bucket. In preferred embodiments, a liquid level switch 213 may be utilized to allow nutrient solution 201 to pool at the base of the bucket. In some embodiments, whether nutrient solution 201 is retained in the planting bucket 300 is determined by the user. In other embodiments, the amount of nutrient solution 201 retained in the planting bucket 300 can be adjusted by the user.

The nutrient solution 201 may be pumped from the main reservoir 203 by an outlet pump 205. In preferred embodiments, the outlet pump 205 may be a barrel-type pump or any other type of pump suitable to supply water to the plants from the main reservoir 203. In some embodiments, the nutrient solution 201 passes through an ultraviolet lamp 207 to sterilize the nutrient solution 201. The outlet pump 205 may be configured to supply the water and nutrient solution 201 to the nozzles in the planting bucket 300 as defined by user input. In some embodiments, the outlet pump 205 may supply the nozzles with the nutrient solution 201 at a pressure no less than 30 psi and no greater than 100 psi.

The outlet pump 205 may direct the nutrient solution 201 through a filter module 209 to provide filtration of the nutrient solution 201. In some embodiments, the nutrient solution 201 may also pass through two or more liquid pressure gauges 211 and a filter module 209. The filter module 209 may be positioned between two pressure gauges 211 configured to measure the pressure before and after the filter module 209 to detect and measure pressure differential of the nutrient solution 201 before and after filtration. A pressure differential may result from clogs or obstructions in the filter module 209. If the pressure differential is over a user defined threshold, a user may elect to replace the filters in the filter module 209.

The nutrient solution 201 may be provided to a plurality of plants situated in planting buckets 300 through conduits connected to two or more nozzles positioned at the sides of each planting bucket. Each nozzle may be inserted into side apertures 304 located on the sides of the planting bucket. In preferred embodiments, two side apertures 304 are located on the sides of the planting buckets 300 and two nozzles are inserted into the apertures. The nutrient solution 201 may be pumped through the nozzles and emitted as a liquid or gaseous mist directed at the root zone of a plant situated within the planting bucket. As discussed in detail below, any nutrient solution 201 not absorbed by the roots of the plant can drop down to the bottom of the planting bucket 300 and may be drained from the bucket through a base aperture 307 at the base of the planting bucket. In some embodiments, a valve 404 may be activated to allow the nutrient solution 201 to enter an elevated bypass channel 406 causing a pool of nutrient solution 201 to accumulate in the planting basket. Nutrient solution 201 drained from the planting basket 306 may be pumped back into the main reservoir 203 by a secondary pump 215. In some embodiments, the nutrient solution 201 drained from the planting basket 306 may enter a secondary reservoir when the valve 404 is activated and subsequently pumped by the secondary pump 215 into the main reservoir 203.

### Height Adjustable Lighting Assembly

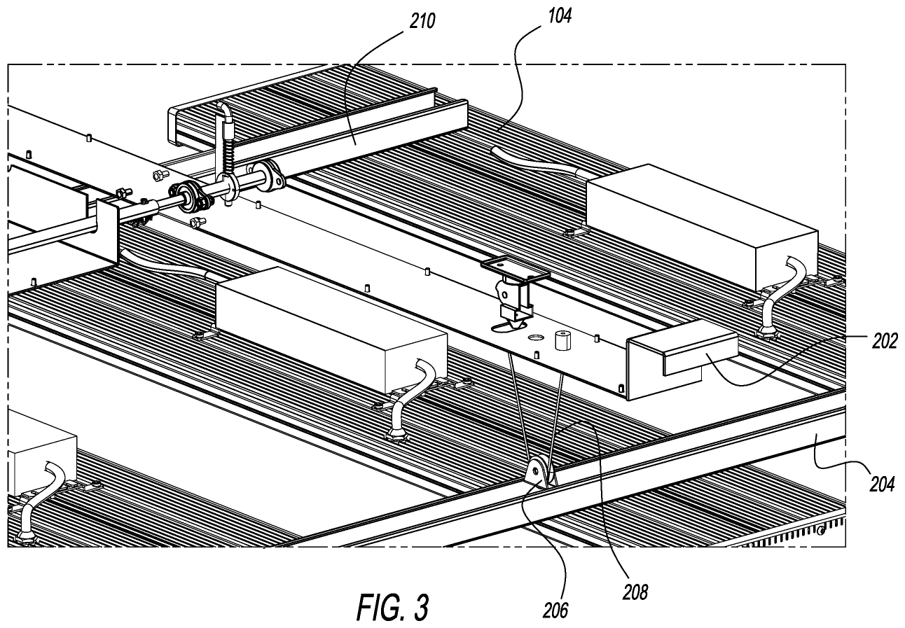

In reference to FIG. 3, a lighting assembly 140 for plant cultivation is illustrated. As shown, the lighting assembly 140 may be comprised of a lighting assembly 140 mount and a series of luminaires 201. The lighting assembly 140 mount may include a host frame 202 having a first end and a second end. The first end of the host frame 202 may be connected to a left arm frame while the second end of the host frame 202 may be connected to a right arm frame. In preferred embodiments, the left arm frame may be attached at the first end perpendicular to the host frame. The right arm frame may be similarly attached to the host frame 202 at the second end. The host frame 202 may be attached to the center or near the center of the left and right arm frame. Near the ends of the left and right arm frame may be attached a front support beam 210 and a rear support beam. The front 210 and rear support beams 204 may be situated across the left and right arm frames.

As illustrated in FIG. 3, the front 210 and rear support beams 204 may be attached to a series of luminaires 201 to provide light to the plants situated below the lighting assembly 140. In preferred embodiments, the front 210 and rear support beams 204 may be connected to the lighting assembly 140 mount through a suspension system. The suspension system may be configured as a wire rope winch system 206 where a wire rope 208 is wound around a rotating drum and the height of the luminaires 201 is raised or lowered by turning by a crank, a motor, or other power source. In alternate embodiments, the suspension system may include suspended from chains, cables, ropes, or other mechanical structures capable of raising or lowering the luminaires 201.

As the plants grow, the height of the luminaries to achieve optimal illumination height and coverage area may change. The growth of the plants may be tracked manually periodically or through sensors, such as an optical sensor. Sensors may be positioned around the plants and secured on the host frames, support beams, or the lighting assembly. In other embodiments, the height of the plants may be tracked using cameras that capture images of the plants. Heights of the plants may be evaluated by personnel or through computer software. In some embodiments, sensors may be adapted for each grow tower, allowing lighting assemblies in each individual grow tower to be raised or lowered independently based on the height of the plants in each grow tower. For example, plants serviced by different sets of luminaires may be in different grow stages and thus the height of the luminaires for each set of plants would be positioned at different heights to achieve optimal illumination for each particular stage of development. Each luminaire in the lighting assembly may also be associated with its own set of sensors, allowing each luminaire to be raised or lowered independently. In other embodiments, all luminaires and lighting assemblies may be associated with the same set of sensors.

In some embodiments, the lighting assemblies or luminaires may be raised or lowered periodically through a predetermined schedule or in response to the data received from sensors positioned around the plants. Data may be sent from the sensors to the system controller. The system controller may react to the data and adjust the height of the luminaires accordingly.

The luminaire may use any light or lamp suitable for horticulture, including LED, HID, fluorescent, incandescent, plasma, metal halide, and high-pressure sodium lights. In a preferred embodiment, the luminaire is adapted with a printed circuit board having embedded LED lights. The LED lights may be distributed across the printed circuit board in a manner to provide uniform lighting to the plants situated below the luminaires. In some embodiments, the density of LED lights distributed across the printed circuit board may be the lowest in the center of the printed circuit board and progressively increase towards the borders of the board. Because the center of the printed circuit board will have the greatest amount of light, increasing the density of LED lights near the edges of the printed circuit board can aid in maintaining an even distribution of light.

The lighting assembly 140 may be configured to respond to inputs to the system controller. The system controller 102 may take inputs from a program, a human user, external sensors, and/or a network interface. Based on the inputs, the system controller 102 may provide electronic and/or mechanical outputs to the lighting assembly 140. The system controller 102 may be connected to the lighting assembly 140 through a serial interface. The system controller 102 may also be coupled with an Ethernet controller and a network interface. The system controller 102 may receive inputs from the network interface, a human user, an application program, and/or a microcontroller. The lighting assembly 140 may also respond to outputs from the system controller 102 to adjust the height of the lighting assembly 140. The system controller 102 may raise or lower the lighting assembly 140 based on data from one or more sensors. The sensors may be configured to measure light intensity or distance from the plant canopy. In some embodiments, distance sensors can be placed on the lighting assembly 140, including placement among LED lights. In other embodiments, a plurality of distance sensors may be employed. The lighting assembly 140 may be raised or lowered based on the weighted average of the data received from the plurality of distance sensors.

### Planting Bucket and Liquid Level Switch

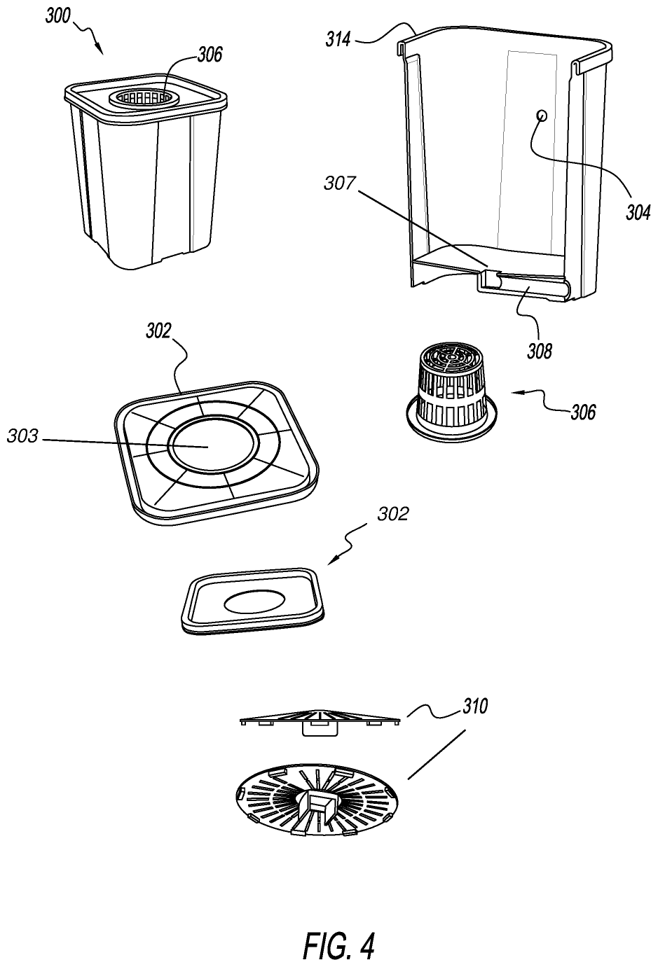

Referring to FIG. 4, an exemplary planting bucket 300 is illustrated. The planting bucket may be a chamber adapted to receive and cultivate a plant with an exposed root mass. As shown, a planting bucket 300 is molded with lateral sidewalls to provide an interior cavity with sloping sides configured to direct water and nutrient solution 201 to a base aperture 307 located in the base of the planting bucket. In some embodiments, the base is formed with an inclined plane directing the water and nutrient solution 201 towards a base aperture 307 forming an outlet for the nutrient solution. In the preferred embodiment, a bucket lid 302 may be provided as an attached to the top of the planting bucket. The bucket lid 302 may be of the same shape as the lipped edge 314 of the planting bucket 300 to which the lid is being attached. For example, if the lipped edge 314 of the planting bucket 300 has round shape, the peripheral edge of the lid 302 will be round in shape. As another example, if the bucket is generally square in shape, the lid 302 will also have the same generally square shape. The bucket lid 302 may generally be of greater overall dimension than the associated bucket, thus enabling the lid to drape over the lipped edge 314 of the bucket, and having skirt members positioned within the interior and exterior of the bucket. In some embodiments, the bucket lid 302 may provide a seal along the edges of the planting bucket.

In preferred embodiments, the bucket lid 302 may be formed with a lid aperture 303 through the surface of the lid. The lid aperture 303 may be fitted with a planting basket 306 to hold the roots of a plant. The planting basket 306 may be round and have a lip 314 around the top edge of the planting basket 306 that is slightly larger in diameter than the lid aperture 303 formed through the bucket lid. The lip 314 of the planting basket 306 may rest over the lid aperture 303 of the bucket lid 302 thereby allowing the bottom portion of the basket 306 to hang underneath the bucket lid 302 within the planting bucket 300 when the planting bucket 300 is sealed by the bucket lid. The base and the sides of the basket 306 may be defined with a plurality of apertures to allow plant roots to grow and expand into the planting bucket. In some embodiments, the root mass of the plant is entirely contained within in interior cavity of the planting bucket.

In some embodiments, the base aperture 307 is located on the base of the planting bucket. In other embodiments, the base aperture may be formed through the lateral sidewalls of the planting bucket, at or near the bottom of the lateral sidewalls. In further embodiments, the base aperture may be formed through the lateral sidewalls of the planting bucket below the root mass of the plant in the interior cavity of the planting bucket. Drainage of the nutrient solution through the base aperture may be achieved through gravity or a pump.

The base aperture 307 may be sealed with a filter plug 310 to prevent roots from entering or blocking the outlet conduit 308. The diameter of the filter plug 310 may be larger than the size of the base aperture 307 and may also include deformable tabs that allow the filter plug 310 to be removably attached to the base aperture 307. The filter plug 310 may include a plurality of slits or holes to allow the passage of a water and nutrient solution 201 but small enough to prevent the roots from entering the aperture. The base aperture may be an outlet

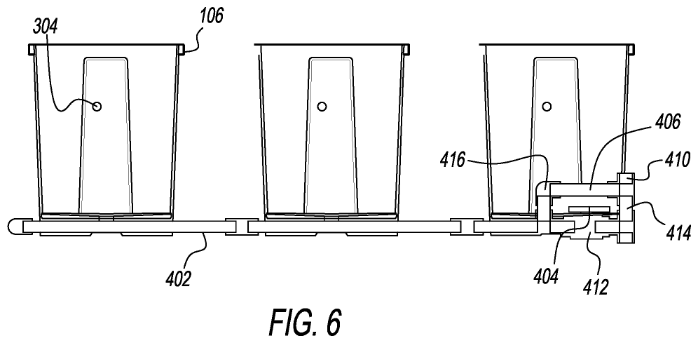

The base aperture 307 may be connected to an outlet conduit 308 positioned underneath the base of the planting bucket. Nutrient solution 201 not absorbed by the roots of the plant can drain from the bucket through the outlet conduit 308. The outlet conduit 308 may be connected to a drainage conduit 402 to allow the excess nutrient solution 201 to be pumped back into the main reservoir 203. As illustrated in FIG. 6, in some embodiments, the outlet conduits 308 from a plurality of planting buckets 300 may be connected to a common drainage conduit 402.

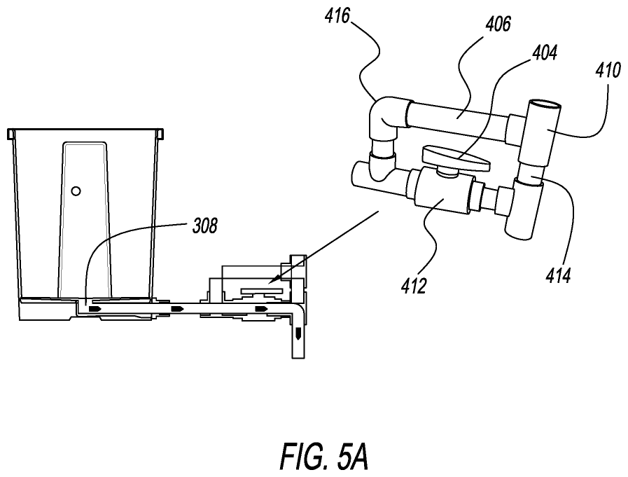

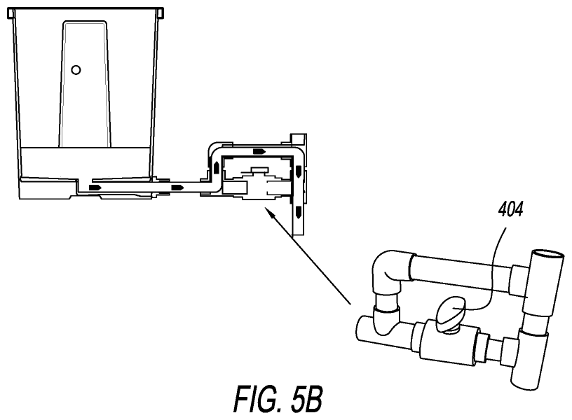

As seen in the preferred embodiments illustrated in FIGS. 5A and 5B, the drainage conduit 402 is connected to a liquid level switch 213. The liquid level switch 213 may be adapted to allow a predetermined level of nutrient solution 201 to remain in the planting bucket 300 thereby immersing the roots of a plant in the nutrient solution 201. The liquid level switch 213 provides at least two pathways for the drainage of nutrient solution 201. The liquid level switch 213 may also include a valve 404 to regulate the flow of the nutrient solution 201. When the valve 404 is open, liquid may flow freely through the drainage conduit 402. When the valve 404 is closed, the flow of liquid is restricted through the drainage conduit 402 and the nutrient solution 201 enters an elevated bypass channel 406. At least one portion of the bypass channel may be higher than the bottom of the planting bucket. The bypass channel 406 may be configured with a bypass inlet 416 and a bypass outlet 414. The bypass channel 406 may be a u-shaped conduit connected to the drainage conduit 402 situated so that the bypass inlet 416 and the bypass outlet 414 is substantially perpendicular to the axis of the outlet conduit 308. The bypass channel 406 may be elevated above the outlet conduit.

When the valve 404 is closed, nutrient solution 201 may retained in the planting bucket 300 at a height equivalent to the height of the bypass channel. Under the principles of Pascal's law, the height of nutrient solution in the bypass channel should be equivalent to the height of the retained nutrient solution in the planting bucket. An aperture or outlet for air may be formed through the bypass channel to avoid siphoning nutrient solution out of the planting bucket. In preferred embodiments, the height of the bypass channel 406 may be raised or lowered resulting in a corresponding raising or lowering of the nutrient solution 201 level remaining in the planting bucket 300.

In another embodiment, the bypass channel 406 may include a first elbow joint that connects to the bypass inlet 416 so that when it is attached, the bypass inlet 416 is substantially perpendicular to the axis of the bypass passage. A second elbow joint may be connected to the bypass outlet 414 in a similar manner. The first and second elbow joint may be connected by an additional conduit to allow liquid to flow between the bypass inlet 416 and the bypass outlet 414. The valve 404 may be situated on the outlet conduit 308 between the bypass inlet 416 and the bypass outlet 414 allowing the water and nutrient solution 201 to flow through the bypass channel 406 when the valve 404 is closed. The bypass channel 406 may also be configured to allow the height of the remaining nutrient solution 201 in the planting bucket 300 to achieve hydrostatic equilibrium with the height of the bypass channel 406. In some embodiments, the bypass inlet may be disposed through the planting bucket.

In certain embodiments, if the level of nutrient solution in the planting bucket is higher than the height of the bypass channel, an overflow pump may be used to draw nutrient solution out of the planting bucket into a bypass reservoir. The bypass reservoir may also be adapted with a plurality of float switches to monitor the level of the nutrient solution in the temporary reservoir. For example, a first float switch may be adapted to stop the bypass pump 215 from operating if the nutrient solution level is lower than the level designated by the first float switch. A second float switch may be adapted to actuate the bypass pump 215 when the nutrient solution level rises above a second designated level. The second designated level may be higher relative to the level designated by the first float switch. A third float switch may be adapted to trigger an audio and/or visual alarm if the nutrient solution level rises above a third designated level. The third designated level may be higher relative to the second designated level. In some embodiments, the float switches may be triggered at the same height as the bypass channel. For example, if the level of the retained nutrient solution in the planting bucket surpasses the height of the bypass channel, the second float switch may be triggered. The float switches may be activated by a liquid level switch 213 when the bypass channel 406 is in use.

The walls of the planting bucket 300 may have a plurality of side apertures 304. In preferred embodiments, the walls of the planting bucket 300 may have two side apertures 304 on opposite sides of the planting bucket. In other embodiments, the apertures 304 may be formed on adjacent walls of the planting bucket. The side apertures 304 may be fitted with a fluid delivery devices. In some embodiments, the fluid delivery device may be a nozzle configured to provide a water and nutrient solution 201 from the main chamber to inject a liquid, gas or mist to the roots of a plant contained within the planting bucket. Preferably, the nozzles may be configured to provide a mist at a pressure in the range of 30-100 psi. At this pressure, the diameter of the water droplets provided by the nozzles are approximately 20-100 μm. Any excess water and nutrient solution 201 may be drained from the base aperture 307 of the planting bucket 300 preventing the water and nutrient solution 201 from being heated by the lighting assembly 140.

### Scalable Rack

In an exemplary embodiment as illustrated in FIG. 1, a plurality of planting baskets may be arranged in parallel rows along the chassis of a storage rack 106. A plurality of storage racks 106 may be stacked to form a grow tower 108 in which each level of the grow tower 108 contains a plurality of planting baskets arranged in parallel rows. Additional grow towers 108 may be placed adjacent to an existing grow tower 108 and operably connected to the system controller 102. The modular and scalable nature of the grow towers, storage racks 106, and the planting buckets 300 provides for a multi-container grow environment in which a plurality of storage racks 106 may be placed adjacently, stacked or otherwise arranged to establish a large quantity of growing plants in an efficient and cost-effective manner. In one aspect, rows of grow towers 108 may be combined to form a three dimensional arrange of storage racks 106 and arranged in a stacked and dense configuration to maximize the grow space within a certain volume. Each grow tower 108 or storage rack 106 may have its own power supply 110.

The system disclosed herein may further be implemented as a scalable system in which multiple grow towers 108 may be installed into a movable scaffold system. Sets of grow towers 108 may be movably affixed to a scaffold such that the towers may be slid along a track thereby creating easy access to the plants, vessels, lights and irrigation system. It is understood that in the event that one or more planting buckets 300 are removed from the storage racks 106, the remaining planting buckets 300 in the system may still receive the water and nutrient solution 201.

In yet another scalable feature, the system may be expanded to include multiple scaffolds affixed to a frame or compartment interior. Each scaffold, including multiple sets of planting buckets, may be slidably affixed to the frame or a track in the compartment. Further, the planting buckets 300 may be slidable across the scaffold allowing for the creation of multiple grow aisles separated by an access aisle through the multiple scaffolds affixed to the frame. The system's irrigation system may be in fluid communication with the manifolds of each of the grow aisles. The system may further include a control unit in communication with several environmental monitors and controllers. The control unit may be programmed to adapt and adjust the environment in which the system is deployed to create an ideal environment for plant growth.

Various embodiments are described in this specification, with reference to the detailed discussion above and the accompanying drawings. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described components and systems can generally be integrated together in a single product or packaged into multiple products.

Although the subject matter has been described in language specific to structural features and/or methodological acts, it is to be understood that the subject matter is not necessarily limited the specific features or acts described above. Rather, the specific features and acts described above are as example of the disclosed invention.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

The processes described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD ROM and DVD-ROM disks. The processor and the memory can be supplemented by, or incorporated in, special purpose logic circuitry.

The invention claimed is:

1. A plant cultivation system comprising:
a main reservoir configured to hold a nutrient solution;
a fluid delivery device being in fluid communication with the main reservoir;
a cultivation chamber having a lateral sidewall and a chamber outlet, the lateral sidewall defining an interior cavity, the lateral sidewall having a top edge and a bottom edge, wherein the cultivation chamber is adapted to allow the fluid delivery device to inject nutrient solution into the interior cavity of the cultivation chamber, and the chamber outlet is configured to allow drainage of the nutrient solution from the interior cavity of the cultivation chamber;
a drainage conduit disposed at the chamber outlet;
a bypass conduit having a first conduit portion, the first conduit portion of the bypass conduit being in fluid communication with the interior cavity of the cultivation chamber, the first conduit portion of the bypass conduit being positioned higher relative to the bottom edge of the lateral sidewall of the cultivation chamber;
a liquid level switch operatively coupled to the drainage conduit, wherein the liquid level switch is configured to restrict the flow of nutrient solution through the drainage conduit.

2. The plant cultivation system in claim 1, wherein the liquid level switch is moveable between a drainage position and bypass position, and the liquid level switch is configured to direct nutrient solution through the bypass conduit in the bypass position.

3. The plant cultivation system in claim 2, wherein the cultivation chamber is adapted to receive a plant having a root mass, the root mass is disposed inside the interior cavity of the cultivation chamber, and the at least a portion of the root mass is submerged in a volume of nutrient solution retained in the cultivation chamber when the liquid level switch is in the bypass position.

4. The plant cultivation system in claim 3, further comprising an overflow pump configured to pump nutrient solution from the interior cavity when the water level of the volume of nutrient solution is higher than the first conduit portion of the bypass conduit.

5. The plant cultivation system in claim 2, wherein the bypass conduit has an air aperture.

6. The plant cultivation system in claim 1, wherein the drainage conduit has a first drainage end and a second drainage end, the bypass conduit has a first bypass end and a second bypass end, the first drainage end is connected to the first bypass end, and the second drainage end is connected to the second bypass end.

7. The plant cultivation system in claim 1, wherein the liquid level switch is moveable between a drainage position and bypass position, and the nutrient solution does not flow through the first conduit portion of the bypass conduit when the liquid level switch is in the drainage portion.

8. The plant cultivation system in claim 1, wherein the fluid delivery device is a nozzle.

9. The plant cultivation system in claim 1, wherein the first conduit portion for the bypass conduit can be raised or lowered.

10. The plant cultivation system in claim 1, further comprising a sterilization device in fluid communication with the main reservoir.

11. The plant cultivation system in claim 1, further comprising a filtration system in fluid communication with the main reservoir.

12. The plant cultivation system in claim 9, further comprising a first pressure sensor and a second pressure sensor, wherein the filtration system is disposed between the first pressure sensor and the second pressure sensor.

13. The plant cultivation system in claim 3, further comprising a lighting unit configured to being raised or lowered.

14. A method for plant cultivation comprising:
providing a main reservoir configured to hold a nutrient solution;
depositing a plant having a root mass in a cultivation chamber having a lateral sidewall and a chamber outlet, the lateral sidewall defining an interior cavity, the lateral sidewall having a top edge and a bottom edge, and the chamber outlet is configured to allow drainage of the nutrient solution from the interior cavity of the cultivation chamber;
delivering the nutrient solution from the main reservoir to the root mass through a fluid delivery device; wherein the fluid delivery device is disposed through the lateral sidewall of the cultivation chamber
providing a nutrient solution retention system comprising:
a drainage conduit disposed at the chamber outlet;
a bypass conduit having a first conduit portion, the first conduit portion of the bypass conduit being in fluid communication with the interior cavity of the cultivation chamber, the first conduit portion of the bypass conduit being positioned higher relative to the bottom edge of the lateral sidewall of the cultivation chamber;
a liquid level switch operatively coupled to the drainage conduit, wherein the liquid level switch is configured to restrict the flow of nutrient solution through the drainage conduit.
